(19) United States
(12) Patent Application Publication
(10) Pub. No.: US 2013/0167375 A1
(43) Pub. Date: Jul. 4, 2013

(54) APPARATUS AND METHOD FOR PROCESSING A SEALING ELEMENT LOCATED WITHIN THE HOUSING OF A GAS TURBINE

(71) Applicant: MTU Aero Engines GmbH, Muenchen (DE)

(72) Inventors: Juergen ROESING, Sehnde (DE); Frank Seidel, Isernhagen H.B. (DE); Niels Weidlich, Neustadt (DE)

(73) Assignee: MTU Aero Engines GmbH, Muenchen (DE)

(21) Appl. No.: 13/677,907

(22) Filed: Nov. 15, 2012

(30) Foreign Application Priority Data
Nov. 18, 2011 (EP) EP11189710.4-1267

(51) Int. Cl. B23P 15/00

(52) U.S. Cl. CPC B23P 15/00
USPC 29/888.3; 29/33 R

(57) ABSTRACT

A machining or processing apparatus (14) for machining or processing a sealing element (16) located within a housing (12) of a gas turbine (10), the machining or processing apparatus (14), at least in the partially assembled state of the gas turbine (10), being at least partly introducible through a port (22) of the housing (12) into an interior space (24) of the gas turbine (10) and including a machining or processing device (15) which allows work to be performed on the sealing element (16) upon introduction of the machining or processing apparatus (14) under relative movement of the machining or processing device (15) and the sealing element (16). In addition, a method for machining or processing a sealing element (16) located within a housing (12) of a gas turbine (10).

This claims the benefit of European Patent Application EP 111 897 10.4-1267, filed Nov. 18, 2011 and hereby incorporated by reference herein.

The present invention relates to a machining or processing apparatus, as well as to a method for machining or processing a sealing element configured within a housing of a gas turbine.

### BACKGROUND

In gas turbines, such as aircraft engines, for example, leakage flowing through gaps between cooperating components moving relative to one another, reduce efficiency. To minimize these gap losses, it is imperative that the gap between the rotor and the static housing components be kept as small as possible during operation of the gas turbine. The gap dimensions between the housing and the rotor of a gas turbine have a significant effect on the efficiency of the gas turbine. For that reason, one or a plurality of gap dimension-defining sealing elements, such as a run-in coating or the like, is/are usually provided between the components moving relative to one another, in order to minimize the gap dimensions between the static and the dynamic components, the sealing element(s) forming a sealing surface. However, the high loads acting on the sealing element and the resultant abrasive wear thereto cause the gap dimensions to increase over the course of a gas turbine operation, resulting in both a power loss, as well as increased fuel demand.

The gap dimensions are, therefore, readjusted during overhaul of the gas turbine in question. To this end, the gas turbine is typically disassembled, to enable the components in question and, in particular, the sealing element(s) to be repaired in the worn regions. The World Patent Application WO 2001/076549 A1 describes an alternative method where sealing elements, which are in the installed state during maintenance of an aircraft engine and form a common sealing surface that extends over the entire periphery of the turbine housing component, are coated with a ceramic material.

Here too, however, the aircraft engine must first be dismounted from the aircraft and subsequently disassembled to the module level, resulting in correspondingly high maintenance costs and long servicing times.

### SUMMARY OF THE INVENTION

It is an object of the present invention to provide a machining or processing apparatus, as well as a method for machining or processing a sealing element of a gas turbine that render possible a more rapid and cost-effective machining or processing of the sealing element.

The present invention provides a machining or processing apparatus, as well as by a method for machining or processing a sealing element configured within a housing of a gas turbine.

In the case of a machining or processing apparatus that renders possible a more rapid and cost-effective machining or processing of a sealing element configured within a housing of a gas turbine, the present invention provides that the machining or processing apparatus, at least in the partially assembled state of the gas turbine, be at least partly introducible through a port of the housing into an interior space of the gas turbine and include a machining or processing device which allows work to be performed on the sealing element upon introduction of the machining or processing apparatus under relative movement of the machining or processing device and the sealing element. Thus, in contrast to the related art, the machining or processing apparatus according to the present invention allows work to be performed on the sealing element without the associated gas turbine having to be completely disassembled or, in the case of an aircraft engine, having to be additionally dismounted from an airplane wing. Instead, the machining or processing apparatus according to the present invention makes it possible, for example, for work to be performed on the inner sealing elements of gas turbines embodied as aircraft engines mounted on aircraft (generally referred to as “on-wing” repair), since the machining or processing apparatus merely needs to be partially or completely introduced through the port of the turbine housing, thereby allowing work to be performed on the sealing element under relative movement of the machining or processing device and the sealing element. The port may be a frequently provided maintenance port, for example, and/or a front, rear or side port of the gas turbine (viewed in the flow direction). This makes it possible to very quickly and cost-effectively restore the desired gap dimensions and, therefore, the original efficiency of the gas turbine, thereby also achieving considerable savings in fuel consumption. Moreover, the overhaul-dependent servicing times for the gas turbine may be advantageously reduced, making it possible to realize further cost savings.

One advantageous embodiment of the present invention provides that the machining or processing apparatus be designed for machining or processing a sealing element that is fixed to the housing and/or a sealing element that is fixed to the rotor and/or to be configurable on the housing and/or on a rotor of the gas turbine. This renders possible an especially flexible use of the machining or processing apparatus for machining or processing stator- and/or rotor-side sealing elements.

Further advantages are derived in that the machining or processing apparatus includes a holding device that is joined to the machining or processing device and that enables the machining or processing apparatus to be detachably secured to a component of the gas turbine. As a result, the machining or processing apparatus may be very quickly and simply placed in a defined position to allow work to be performed on the sealing element, and removed again following machining or processing. In addition, an especially high machining or processing precision along with a correspondingly accurate adjustment of the gap dimensions are made possible by the securing in position of the machining or processing apparatus.

Another advantageous embodiment of the present invention provides that the holding device be configured for releasably fixing the machining or processing apparatus to the housing and/or to the rotor, in particular, between adjacent blades of the rotor. An especially high processing precision in the processing of sealing elements that are fixed to the housing and/or to the rotor may be hereby ensured. The machining or processing apparatus may be very readily fixed to the rotor and moved along the same while the rotor is rotated to enable work to be performed on a sealing element that is fixed to the housing in that the holding device, in particular, permits a fixing in position between adjacent rotor blades.

The machining or processing apparatus may be secured very rapidly, readily and without the danger of turbine components being damaged by deformation and, correspondingly, may be readily removed again in that the holding device includes a flexible holding member, in particular, a fluid sack, whose volume may be increased to secure the machining or processing apparatus and reduced to release the machining or processing apparatus. In addition, the variable outer contour of the holding member allows the machining or processing apparatus to be readily secured in position to gas turbines having different designs. This makes it possible for the machining or processing apparatus to be used for different aircraft turbines, for example. Volume may be increased, for example, by a liquid and/or gaseous operating medium acting on the holding member. Accordingly, volume may be decreased by removing the operating medium from the holding member. Alternatively or additionally, the holding device may include a preferably switchable magnet and/or a fixing clamp to releasably fix the machining or processing apparatus. The machining or processing apparatus may by secured in position and, correspondingly readily removed again, likewise very rapidly, simply, and without the danger of damaging the turbine components.

Another advantageous embodiment of the present invention provides that the machining or processing device include a cutting tool, in particular, a grinding tool, for changing the shape of the sealing element, and/or a spatula for applying and/or distributing a material to be applied to the sealing element, and/or a material reservoir for preparing the material to be applied to the sealing element, and/or a curing device for curing material applied to the sealing element, and/or an energy source, in particular a battery, for supplying the machining or processing apparatus with operating energy, and/or a control or regulating device for controlling and/or regulating the machining or processing apparatus, and/or a feed line, in particular a tubing via which material may be transported to the sealing element and through a discharge orifice of the feed line, in particular, through a nozzle to the sealing element. As a result, the machining or processing apparatus may have an especially flexible design and be optionally used for applying material to the sealing element and/or for removing it therefrom, making possible an especially precise adjustment of the gap dimensions. Moreover, the machining or processing apparatus may be designed as an autonomous tool that is able to machine and process the sealing element without any external supply, control or the like, once it has been positioned and, as the case may be, fixed in a desired position to the gas turbine. Appropriate materials are, in particular, those having a pasty consistency suited for spatula application.

Another advantageous embodiment of the present invention provides that at least the machining or processing device be designed to be independently movable, in particular, flexible and/or singly or multiply articulated. This permits the simple and precise machining or processing of sealing elements having complex geometries, respectively difficult-to-access sealing elements.

It has been shown to be advantageous in a further embodiment for the machining or processing apparatus to include a determination device for analyzing the sealing element. The state of the sealing element may be hereby inspected before, during and/or after the machining or processing, making it possible to reliably assess the state of the sealing element. The determination device may include a camera, a sensing device, a laser optic or the like, for example.

Another advantageous embodiment of the present invention provides that the machining or processing device be configured at a distal or proximal end region of the machining or processing apparatus relative to the insertion direction of the machining or processing apparatus. As a result, the machining or processing apparatus may be readily adapted for various purposes.

Another aspect of the present invention relates to a method for machining or processing a sealing element configured within a housing of a gas turbine, where at least the steps of at least partially introducing a machining or processing apparatus through a port of the housing into an interior space of the gas turbine and of machining or processing the sealing element using a machining or processing device of the machining or processing apparatus are carried out under relative movement of the sealing element and the machining or processing device, all method steps taking place at least in the partially assembled state of the gas turbine. Within the context of the present invention, the assembled state of the gas turbine is understood to be the non-dissassembled state thereof. For example, a gas turbine embodied as an aircraft engine may be machined and processed in the installed state on the airplane, thus “on-wing.” The port may be a frequently provided maintenance port, for example, and/or a front, rear or side port of the gas turbine (viewed in the flow direction). Using the method according to the present invention, the desired gap dimensions and, thus, the original efficiency of the gas turbine may be restored very quickly and cost-effectively, thereby also achieving considerable savings in fuel consumption. Moreover, the overhaul-dependent servicing times for the gas turbine are advantageously reduced, thereby realizing further cost savings. The machining or processing apparatus used within the scope of the method may be designed in accordance with one of the preceding exemplary embodiments. The features derived herefrom and the advantages thereof may be inferred from the above descriptions.

Another advantageous embodiment of the present invention provides for at least the machining or processing device to be partially and/or completely introduced through the port of the housing into the interior space of the gas turbine, allowing work to be performed on the gas-turbine sealing element that is fixed to the rotor by the machining or processing device under relative movement of the rotor and the housing. This makes possible an especially rapid and simple machining or processing of a rotor-side sealing element that seals the dynamic rotor from static components of the gas turbine, for example, from guide vanes or the like.

Alternatively, it has been shown to be advantageous for the machining or processing apparatus to be initially completely introduced into the interior space of the gas turbine and to be releasably secured to the rotor of the gas turbine by a holding device, allowing the gas-turbine sealing element, which is fixed to the rotor, to be machined and processed by the machining or processing device under relative movement of the rotor and the housing. This allows the machining or processing apparatus to be used as an at least substantially autonomous tool for processing a housing-side sealing element, the housing-side sealing element being used for sealing the housing or a component that is fixed to the housing from the dynamic rotor of the gas turbine.

An especially precise change in the form and property of the sealing element and, thus, a correspondingly precise adjustment of the gap dimensions is made possible in a further embodiment of the present invention in that, during machining or processing of the sealing element, material is applied thereto, and/or applied material is distributed over the sealing element, and/or material applied to the sealing element is cured, and/or material is removed from the sealing element. The material is preferably used in pasty form.

Further advantages are derived in that the sealing element and the machining or processing device are moved relative to one another manually and/or by a motor, in particular a boroscope motor, and/or at a speed of between 1 rpm and 10 rpm. For example, a rotor of the gas turbine may be manually rotated once the machining or processing apparatus is positioned in order to generate the relative movement between the machining or processing device and the sealing element to be worked on. Alternatively, for example, a boroscope motor may be used to rotate the rotor, in order to machine and process the sealing element. A high machining or processing precision is achieved in a shortest possible machining or processing time in that the sealing element and the machining or processing device are moved relative to one another at a speed of between 1 rpm and 10 rpm. A speed of between 1 rpm and 10 rpm is understood here, in particular, to be speeds of 1 rpm, 2 rpm, 3 rpm, 4 rpm, 5 rpm, 6 rpm, 7 rpm, 8 rpm, 9 rpm or 10 rpm.

### BRIEF DESCRIPTION OF THE DRAWINGS

Other features of the present invention are derived from the claims, the exemplary embodiments, as well as in light of the drawings. The aforementioned features and feature combinations, as well as the features and feature combinations mentioned in the exemplary embodiments may be used not only in the particular stated combination, but also in other combinations or alone, without departing from the scope of the present invention. The figures show:

FIG. 1 a schematic sectional view of a gas turbine, in whose housing, a machining or processing apparatus according to the present invention is configured for machining or processing a sealing element;

FIG. 2 another schematic sectional view of the gas turbine, in whose housing, four different specific embodiments of the machining or processing apparatus according to the present invention are shown; and

FIG. 3 another schematic sectional view of the gas turbine including a machining or processing apparatus partly configured in accordance with the present invention within the housing.

### DETAILED DESCRIPTION

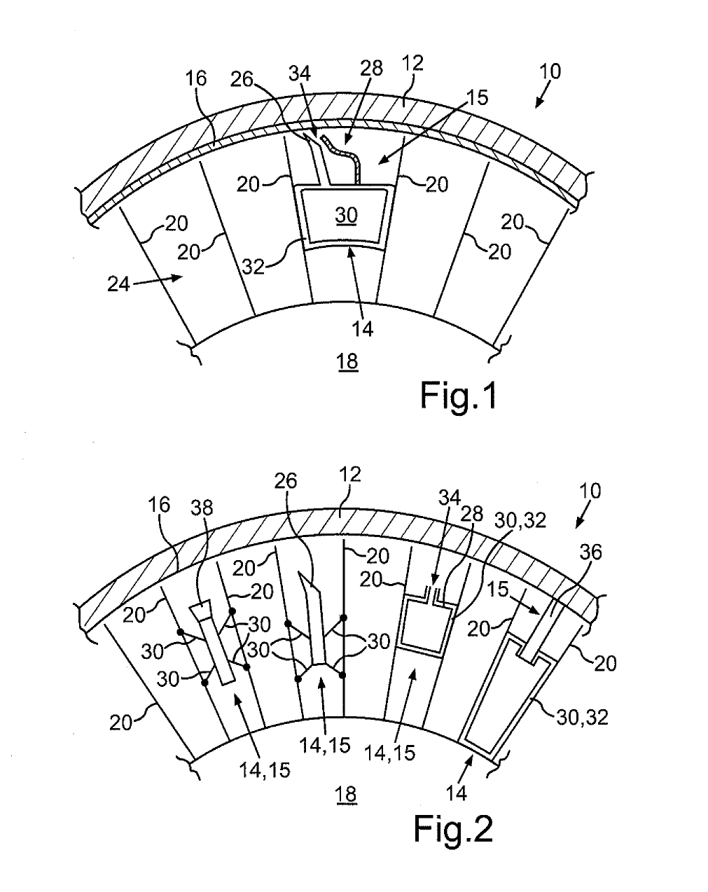

FIG. 1 shows a schematic and cutaway sectional view of a gas turbine 10 embodied as an aircraft engine, in whose housing 12, a machining or processing apparatus 14 is located for machining or processing a sealing element 16 that is fixed to the housing. Sealing element 16, which, in the present case, is in the form of what is generally referred to as run-in seals and forms a stator ring, is used in a manner known per se for sealing static housing 12 from a bladed rotor 18 and reduces leakage flows through the gap between blade tips of rotor blades 20 and housing 12. To minimize these gap losses and, thus, to optimize the efficiency of gas turbine 10, the smallest possible gap must be maintained between rotor blades 20, which normally operate at high speed, and sealing element 16 surrounding rotor 18 during operation of gas turbine 10. This is problematic since rotor blades 20 lengthen radially in response to high loads, both due to thermal stresses, as well as centrifugal forces, while housing 12 typically only undergoes a slight thermal expansion and thus increase in the housing periphery. Thus, the gap dimensions are variable during operation of gas turbine 10. In various operating states of gas turbine 10, a running-in of the blade tips into sealing element 16 may occur, resulting in an ablation of material from sealing element 16 and, thus, in an enlarged gap.

With the aid of machining or processing apparatus 14, respectively of the described machining or processing method, the “tip clearance,” i.e., the gap dimensions between the blade tips of rotor blades 20 and sealing element 16 may be adjusted by the machining or processing of sealing element 16, without gas turbine 10 having to be dismantled or disassembled for that purpose. In other words, the optimal state of sealing element 16 may be restored in what is generally referred to as the “on-wing state” of gas turbine 10.

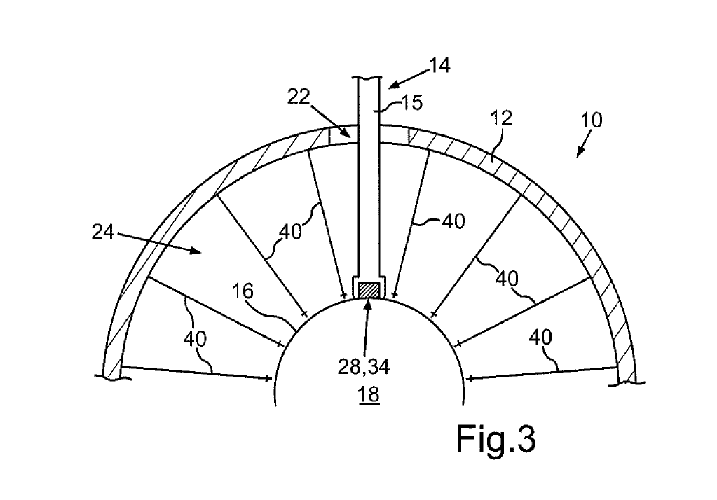

For this purpose, machining or processing apparatus 14 is completely introduced, for example, through a boroscope port 22 (see FIG. 3), which is normally present in the case of aircraft engines, into an interior space 24 of housing 12 and clamped in a defined position between two blades 20. It is generally self-evident, however, that machining or processing apparatus 14 may be introduced through other ports in housing 12 of gas turbine 10. In the present exemplary embodiment, machining or processing apparatus 14 includes a machining or processing device 15 having a leveling lip-type spatula 26 for applying and distributing a material to be applied to sealing element 16, as well as a material reservoir 28 for preparing the material to be applied to sealing element 16. As materials, those in the form of pastes are preferably used since they may be very readily applied to surfaces and distributed thereon. In principle, it may be provided that at least machining or processing device 15 be designed to be independently movable, in particular, flexible and/or singly or multiply articulated.

In addition, machining or processing apparatus 14 includes a holding device 30 for releasably fixing machining or processing apparatus 14 between adjacent blades 20 of rotor 18. Holding device 30, for its part, includes a flexible holding member 32, which is primarily in the form of a fluid or gas sack. Thus, to anchor machining or processing apparatus 14, holding member 32 merely needs to be pumped up or filled with operating medium. The deformability of holding member 32 allows it to automatically conform to the geometry of rotor blades 20. Moreover, any unwanted damage to rotor blades 20 is reliably prevented. To remove machining or processing apparatus 14, the gas or operating medium is discharged again from holding member 32 via a suitable valve device (not shown). In this context, machining or processing device 15 is configured at a distal end region of machining or processing apparatus 14 relative to the insertion direction of the machining or processing apparatus, while holding device 30 is configured at a proximal end region of machining or processing apparatus 14 relative to the insertion direction of machining or processing apparatus 14. Alternatively or additionally, holding device 30 may include a permanent magnet, a solenoid or a mechanical bracket or clamp to allow machining or processing apparatus 14 to be releasably fixed in place.

In the illustrated exemplary embodiment, it is discernible that spatula 26 forms a wall of material reservoir 28, the material held in material reservoir 28—for example, by further inflation of holding member 32—emerging through a discharge orifice 34 in the region of the spatula lip and being applied by spatula 26 onto sealing element 16 and uniformly distributed thereon. During machining or processing of sealing element 16, rotor 18 is rotated manually or with the aid of a boroscope motor at approximately 5 rpm. Machining or processing apparatus 14 is moved along sealing element 16 until the work being performed on sealing element 16 is concluded. During the rotational motion, material reservoir 28 is emptied, and the material is applied to sealing element 16. It may be alternatively provided for the material to be directly applied to housing 12 and form sealing element 16. It may likewise be provided for sealing element 16 to be completely or only partially coated with material.

The composition and viscosity of the material to be used in the particular case is greatly dependent on the field of application, the type of gas turbine 10, and sealing element 16 to be machined and processed. Suited most notably in the compressor region are generally known light metal powders that are mixed with organic binders and the like. In the turbine region, mixtures of ceramic powder and volatizable binders or ceramic/metal mixtures along with binders may be used.

Once sealing element 16 is coated with the material, machining or processing apparatus 14, functioning as an autonomous tool, may be released by the discharging of gas from the holding member and removed from interior space 24. The material is cured and forms a new narrow gap.

FIG. 2 shows another schematic sectional view of gas turbine 10, in whose housing 12, four different specific embodiments of machining or processing apparatus 14 for implementing different processing steps are shown exemplarily. Considered from left to right, the first specific embodiment of machining or processing apparatus 14 includes a machining or processing device 15 having a curing device 38 in the form of a heat and/or UV lamp for actively curing material applied to sealing element 16. In addition, it is discernible in the first exemplary embodiment that holding device 30 includes four retention arms which fix machining or processing apparatus 14 in position between two rotor blades 20.

In the second exemplary embodiment, machining or processing device 15 of machining or processing apparatus 14 merely includes a spatula 26 which is used to distribute already applied material over sealing element 16. Holding device 30 corresponds to that of the first exemplary embodiment.

In the third exemplary embodiment, machining or processing device 15 of machining or processing apparatus 14 includes a material reservoir 28 having a nozzle-type discharge orifice 34 through which the material is sprayed onto sealing element 16. Material reservoir 28 is used at the same time as a feed line for transporting the material to sealing element 16. Holding device 30 includes a flexible holding member 32, which is formed in one piece with material reservoir 28. Accordingly, machining or processing apparatus 14 is fixed in position or removed in the manner described in the context of FIG. 1 by “pumping up” or “evacuating” holding member 32.

Finally, in the right exemplary embodiment, machining or processing apparatus 14 has a machining or processing device 15 which includes a grinding tool 36. Again, holding device 30 includes flexible holding member 32, whose volume may be varied by pumping up or evacuating the same. In contrast to the preceding exemplary embodiments, holding member 32 is configured in a way that allows machining or processing apparatus 14 to be braced against a base member of rotor 18. By pumping up or evacuating holding member 32, the contact pressure of grinding tool 36 may be hereby very readily varied in order to produce a desired contour profile of sealing element 16. A relative movement between grinding tool 36 and sealing element 16 is generated by rotation of the rotor, thereby allowing a grinding process to be carried out.

The illustrated specific embodiments of machining or processing apparatus 14 may be configured in the form of individual tools and be used one after another, respectively independently from one another. For example, using grinding tool 36, the sealing element may be ground before and/or subsequently to the application of material with the aid of spatula 26. Alternatively, it may be provided that a machining or processing apparatus 14 include two or more machining or processing devices 15 described above, so that processing steps for applying and/or removing different material may be carried out using the same machining or processing apparatus 14, respectively at the same time.

It is also self-evident that a plurality of different machining or processing apparatuses 14 may be positioned at different locations on gas turbine 10, and different machining or processing steps carried out at the same time, but spatially separately from one another. Again, it is important to note that all machining or processing steps may be implemented, respectively are implemented in the assembled or at least in the partially assembled state of gas turbine 10.

FIG. 3 shows another schematic sectional view of gas turbine 10 having a machining or processing apparatus 14 partly configured within housing 12. In contrast to the preceding exemplary embodiments, machining or processing apparatus 14 is used for machining or processing a sealing element 16 that is fixed to the rotor. Sealing element 16, which is fixed to the rotor, is used for sealing rotor 18 from guide vanes 40 of gas turbine 10, which are fixed to the housing.

To machine and process sealing element 16, which is fixed to the rotor, machining or processing device 15 of machining or processing apparatus 14 is first at least partially introduced through a boroscope port 22 of housing 12 into interior space 24 of gas turbine 10. Rotor 18 is subsequently rotated manually or by motor, whereby sealing element 16 moves relative to machining or processing device 15. In the illustrated exemplary embodiment, machining or processing device 15 includes a material reservoir 28, through whose discharge orifice 34, material is applied to and distributed over sealing element 16 during rotation of rotor 18. Alternatively or additionally, it is self-evident that a machining or processing apparatus 14 having a differently designed machining or processing device 15 may also be used during machining or processing of a sealing element 16 that is fixed to the rotor. For example, sealing element 16 may be abraded prior to and/or subsequently to the application of material in order to produce a desired contour profile of sealing element 16. All of the method steps are implemented in the assembled or partially assembled state of the gas turbine, even in the machining or processing of sealing element 16, which is fixed to the rotor.

What is claimed is:

1-14. (canceled)

15. A machining or processing apparatus for machining or processing a sealing element located within a housing of a gas turbine, the machining or processing apparatus, at least in the partially assembled state of the gas turbine, being at least partly introducible through a port of the housing into an interior space of the gas turbine, the machining or processing device comprising:
a machining or processing device capable, upon introduction through the port, of performing work on the sealing element under relative movement of the machining or processing device and the sealing element.

16. The machining or processing apparatus as recited in claim 15 wherein the sealing element is fixed to the housing and/or the sealing element fixed to the rotor and/or mountable on the housing and/or on a rotor of the gas turbine.

17. The machining or processing apparatus as recited in claim 15 further comprising a holding device joined to the machining or processing device, the holding device allowing the machining or processing apparatus to be detachably secured to a component of the gas turbine.

18. The machining or processing apparatus as recited in claim 17 wherein the holding device is configured for releasably fixing the machining or processing apparatus to the housing and/or to the rotor.

19. The machining or processing apparatus as recited in claim 18 wherein the holding device is configured for releasably fixing the machining or processing apparatus between adjacent blades of the rotor.

20. The machining or processing apparatus as recited in claim 17 wherein the holding device includes a flexible holding member whose volume can be increased to secure the machining or processing apparatus and reduced to release the machining or processing apparatus, and/or includes a magnet and/or includes a fixing clamp.

21. The machining or processing apparatus as recited in claim 20 wherein the holding device includes a switchable magnet.

22. The machining or processing apparatus as recited in claim 20 wherein the holding device includes the flexible holding member, the flexible holding member including a fluid sack.

23. The machining or processing apparatus as recited in claim 15 wherein the machining or processing device includes at least one of the following:
a cutting tool to change the shape of the sealing element;
a spatula for applying and/or distributing a material to be applied to the sealing element;
a material reservoir for preparing the material to be applied to the sealing element;
a curing device for curing material applied to the sealing element;
an energy source for supplying the machining or processing apparatus with operating energy;
a control or regulating device for controlling and/or regulating the machining or processing apparatus; and
a feed line via which material can be transported to the sealing element and applied through a discharge orifice to the sealing element.

24. The machining or processing apparatus as recited in claim 23 wherein the machining or processing device includes a cutting tool, the cutting tool including a grinding tool.

25. The machining or processing apparatus as recited in claim 23 wherein the machining or processing device includes the energy source, the energy source being a battery.

26. The machining or processing apparatus as recited in claim 23 wherein the machining or processing device includes the feed line, the feed line including tubing.

27. The machining or processing apparatus as recited in claim 23 wherein the machining or processing device includes a grinding tool.

28. The machining or processing apparatus as recited in claim 15 wherein at least the machining or processing device is designed to be independently movable.

29. The machining or processing apparatus as recited in claim 28 wherein the machining or processing device is flexible and/or articulated.

30. The machining or processing apparatus as recited in claim 15 further comprising an analyzer for analyzing the sealing element.

31. The machining or processing apparatus as recited in claim 15 wherein the machining or processing device is configured at a distal or proximal end region of the machining or processing apparatus relative to the insertion direction of the machining or processing apparatus.

32. A method for machining or processing a sealing element located within a housing of a gas turbine, comprising the following steps:
at least partially introducing a machining or processing apparatus through a port of the housing into an interior space of the gas turbine; and
machining or processing the sealing element by a machining or processing device of the machining or processing apparatus under relative movement of the machining or processing device and the sealing element,
all of the method steps being implemented at least in the partially assembled state of the gas turbine.

33. The method as recited in claim 32 wherein at least the machining or processing device is partially and/or completely introduced through the port of the housing into the interior space of the gas turbine, making it possible for the sealing element of the gas turbine that is fixed to the rotor to be processed by the machining or processing device under relative movement of the rotor and the housing.

34. The method as recited in claim 32 wherein the machining or processing apparatus is initially completely introduced into the interior space of the gas turbine and is releasably secured to the rotor of the gas turbine by a holding device, making it possible for the sealing element of the gas turbine that is fixed to the housing to be machined and processed by the machining or processing device under relative movement of the rotor and the housing.

35. The method as recited in claim 32 wherein material is applied to the sealing element during machining or processing of the sealing element, and/or applied material is distributed over the sealing element, and/or material applied to the sealing element is cured, and/or material is removed from the sealing element.

36. The method as recited in claim 32 wherein the sealing element and the machining or processing device are moved relative to one another manually and/or by a motor, such as a horoscope motor, and/or at a speed of between 1 rpm and 10 rpm.
